(19) United States
(12) Patent Application Publication
(10) Pub. No.: US 2018/0293922 A1
(43) Pub. Date: Oct. 11, 2018

(54) Sign Illuminating Device

(71) Applicant: Arudi Rajagopal, Cincinnati, OH (US)

(72) Inventor: Arudi Rajagopal, Cincinnati, OH (US)

(21) Appl. No.: 15/947,282

(22) Filed: Apr. 6, 2018

Related U.S. Application Data
(60) Provisional application No. 62/482,782, filed on Apr. 7, 2017.

(51) Int. Cl. G09F 13/22; H02S 40/38; H05B 33/08

(52) U.S. Cl. CPC G09F 13/22; H05B 33/0803; H02S 40/38

(57) ABSTRACT

Disclosed herein is a traffic sign illuminating device comprising a light sensor to detect diminished ambient light, and an illuminating means programmed to flash, the latter powered by a source of stored energy that is charged by a solar panel. The device, when positioned in proximity to a sign, preferably a traffic sign, senses twilight conditions, and activates the illuminating means to emit flashing light on the sign for the duration of diminished light conditions. With the arrival of dawn and increased ambient light, the light sensor “instructs” the illuminating means to discontinue flashing and the solar panel begins converting light energy to electrical energy to recharge the source of stored energy.

### CROSS-REFERENCE TO RELATED APPLICATION

This application relies on the filing date of Provisional Application No. 62/482,782 filed Apr. 7, 2017

### BACKGROUND AND FIELD OF THE INVENTION

The sign illuminating device described herein is a self-contained unit functionally comprising a light sensor, a light emitting means, a source of stored energy, processing circuitry and a solar panel. The self-contained device, when placed in proximity to a sign, preferably near the top end of a post or pole supporting a traffic sign senses diminished ambient light and activates a light emitting means to illuminate the sign, preferably with an intermittent flash. This device is intended to be deployed in urban, suburban and rural areas where, for a variety of reasons, traffic signs are not always well illuminated by street lights, ambient lighting, or even headlights. In a preferred embodiment, a battery-powered LED will be programmed to “flash” and dramatically illuminate the proximate sign, preferably a traffic sign treated to respond to illumination with enhanced reflectivity. With the dawning, in most instances, the light sensor will detect emerging sunlight and signal the light emitting means to discontinue flashing, and the enhanced ambient light will enable the solar panel to recharge the source of stored energy.

### DESCRIPTION OF THE PRIOR ART

Relevant to, but easily distinguishable from, the sign illuminating device disclosed herein is the Lighted Address Sign described in U.S. Pat. No. 4,272,901, which issued on Jun. 16, 1981 to Matthews. Described therein is an address sign, especially for houses and other buildings, providing full-time lighting so that the sign is easily readable during both day and night. The sign comprises a back plate, a translucent box-like cover and a plurality of miniature lamps disposed on the back plate to provide uniform illumination of the cover. Opaque numbers are arrayed on the front panel of the cover and are preferably black to provide high contrast for easy day and nighttime reading.

Curiously relevant to the sign illuminating device disclosed herein is the sign illuminating light fixture described in U.S. Pat. No. 6,942,366, which issued to Mohacsi on Sep. 13, 2005. That disclosure describes a light fixture having an electrically powered lamp and one or more reflectors to provide for substantially uniform illumination of a sign with a minimum number of light fixtures.

Relevant yet distinguishable from the illuminating device disclosed herein is a mountable lighting module disclosed by Myers et al. in their U.S. Pat. No. 7,357,527, which issued Apr. 15, 2008. The Myers et al. mountable lighting module uses solar energy to charge a power source for LEDs used for night illumination of a sign, and wherein the mountable lighting module features a housing for the electronics with a clamp for mounting to a sign support and a sign illuminating member (the LED) extending over the sign to illuminate the sign's message.

And finally, a method of illuminating a road sign is described by Watanabe et al. in U.S. Pat. No. 5,818,640, which issued on Oct. 6, 1998. The method employs an external illumination source whereby light emitted from the source forms an incident angle in the range of 0° to 30° at any point on the road sign and the road sign is made of a retroreflective material providing a wide observation angle.

### SUMMARY OF THE INVENTION

Notwithstanding the teachings of the prior art, there remains a need for a method and device for illuminating a sign, typically a traffic sign, during extended periods of reduced ambient light, generally between sunset and sunrise, to alert traffic well in advance of negotiable traffic patterns.

The sign illumination device disclosed herein comprises a bracket attachable to the sign, or more specifically, to the sign post of the sign to be illuminated. An integral part of the bracket is a housing. The housing is sized and designed for the placement of a compartment, which, in turn, is for the containment of electrical components conducive to the illumination of the sign. The components comprise a stored energy source, a light emitting means, a light sensor and processing circuitry providing electrical communication between the energy source, light emitting means and the light sensor.

In a preferred embodiment of the disclosed device, the energy source is a rechargeable battery, the light emitting means is an LED, and the device is equipped with a solar panel for recharging the battery.

### BRIEF DESCRIPTION OF THE DRAWING

FIG. 1 is a perspective view of the sign illuminating device disclosed herein.

FIG. 2 is a perspective view of the disclosed device installed on, and illuminating, a traffic sign, which is drawn in phantom. The housing and compartment of the device are partially sectioned to illustrate a light emitting means that would not normally be visible from this perspective. And,

FIG. 3 is an exploded view of the disclosed device.

### DESCRIPTION OF THE PREFERRED EMBODIMENT

The intended goal and purpose of the illumination device described herein is to improve the visibility of signs, typically traffic signs, at or near intersections, during periods of reduced or diminished ambient light. It can be substantiated that most traffic accidents occur in or near intersections and most of those accidents occur during periods of low light conditions. The device disclosed herein seeks to address and reduce these needless accidents and thereby improve safety.

When the illumination device disclosed herein is securely installed on a post supporting a traffic sign, such as a stop sign, the light emitting means will emit intermittent illumination when ambient light (daylight) falls below a previously determined level. The flashing illumination renders a reflectorized traffic sign readily apparent without regard to the presence of headlights or streetlights.

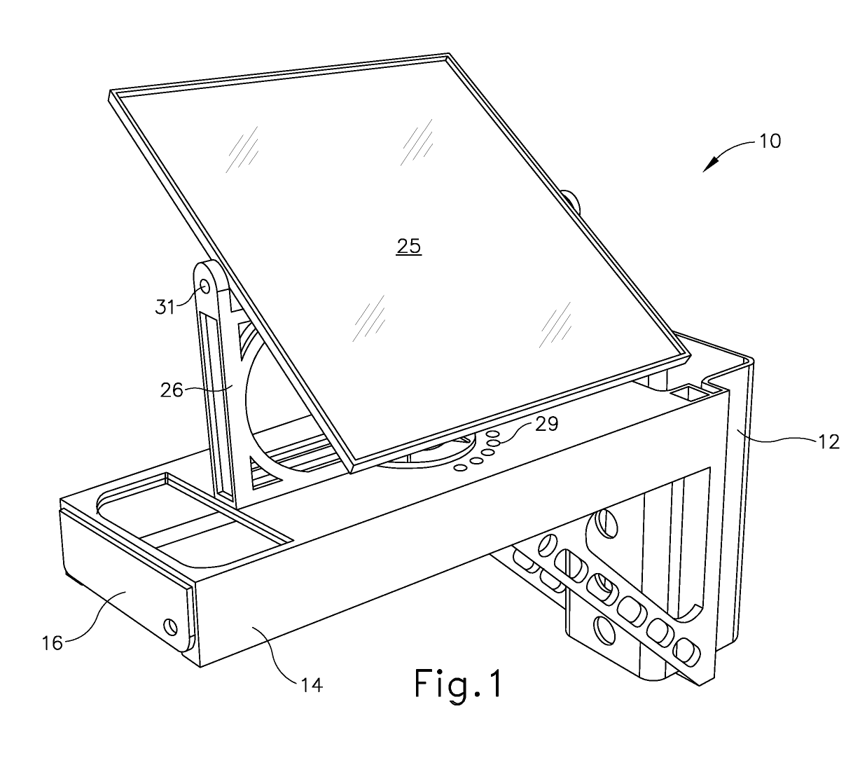

The disclosed illumination device 10 is disclosed in its entirety in the perspective view of FIG. 1. Readily apparent is the bracket 12 for easy attachment of the device to the supporting post of a sign. Preferably the device is attached to the upper extremity of the sign post so that the device can readily illuminate the sign positioned beneath the device. Also apparent in FIG. 1 is the housing 14 that is preferably integrally associated with the bracket 12.

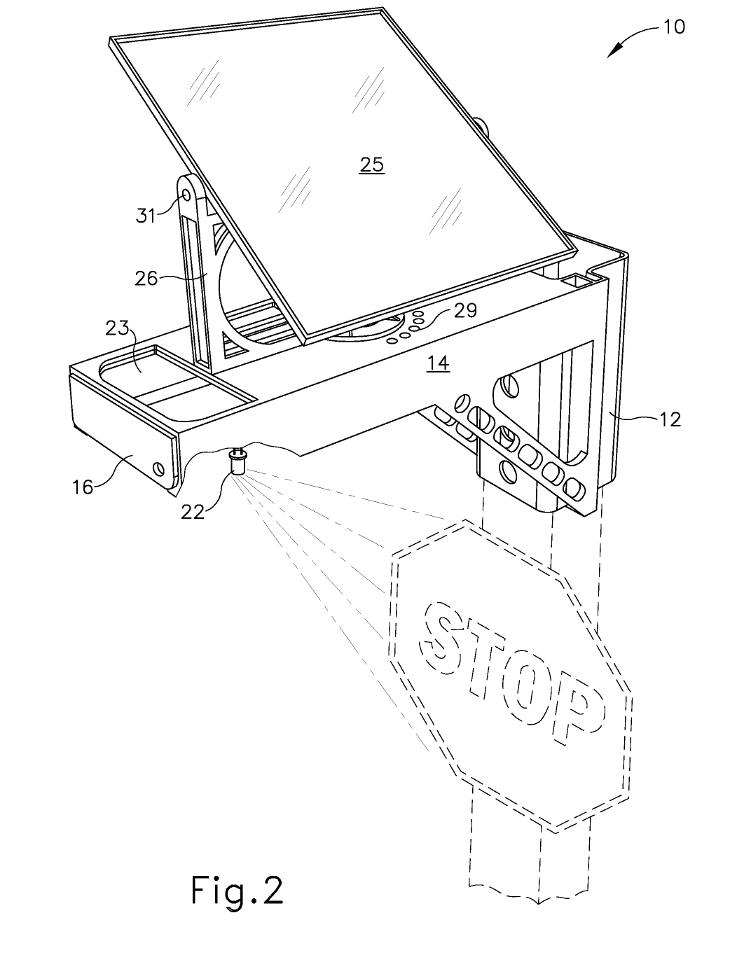

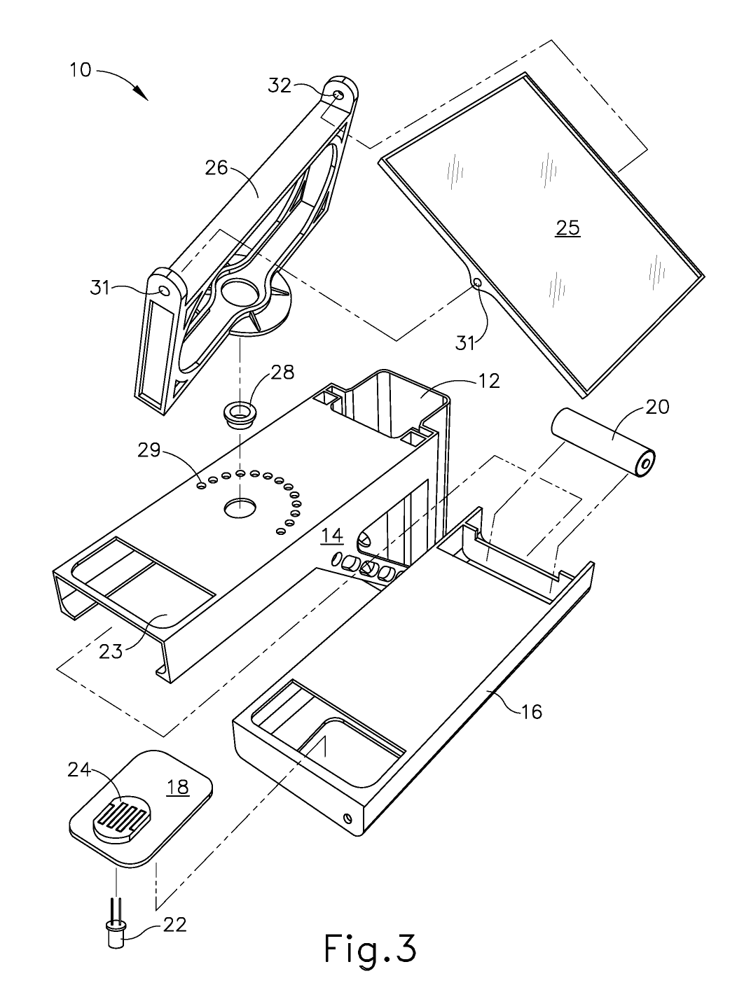

In a preferred embodiment of the device 10, the housing 14 supports a solar panel frame 26 and its associated solar panel 25. And referring to FIGS. 2 and 3, it is apparent that the housing also accommodates a compartment 16 for the containment of electrical components conducive to the functioning of the device. Those components typically include the stored energy source 20, which is typically a battery and preferably a rechargeable lithium battery, a light sensor 24 for detecting ambient light external to the device and a light emitting means 22, generally in the form of an LED. Preferably, all of the components are part of and coordinated by a circuit board 18, which not only connects but also processes and coordinates the electrical components of the device.

FIG. 2 is a perspective view of the disclosed device 10 depicting the device in full operating mode. The device is secured to the anterior end of a sign post and positioned so that the light emitting means 22, situated on the bottom of the device can provide illumination directly on the face of the sign. Preferably, the illumination will be a flashing burst of light and the surface of the sign will be reflectorized to enhance the effect of the flashing light and cause the presence of the sign to be readily apparent in the darkest environment.

FIG. 3 is an exploded view of the illuminating device and all of its components. As stated supra, the device is preferably fitted or equipped with a solar panel 25 for the purpose of collecting light energy for recharging the lithium battery 20. The panel 25 is typically attached to a solar panel frame 26, which is, in turn attached to the top surface of the housing 14 aspect of the device 10. The frame 26 is adjustable to maximize the exposure of the panel to the sun's rays. The attachment of the frame via an annular attachment means 28 provides axial rotation of 360° of the frame and the attached panel, and the axial rotation of the solar panel at rotational points 31 and 32 provide greater than 180° thus maximizing exposure to the sun. After the ideal position of the solar panel is determined, the panel and its frame can be secured with conventional fasteners and semi-circumferential holes 29 and at points 31 and 32 on either side of the panel 25.

The compartment 16 for the containment of the electrical components of the device 10 is sized to fit neatly within the confines of the housing 14. The compartment and its contents are intended to be easily accessed in order to effect repair and replacement.

The stored energy source 20 positioned within compartment 16 will preferably be a rechargeable battery, typically a lithium battery, rechargeable, in most instances by the solar panel 25. The light emitting means 22 is currently an LED and is also positioned within the confines of compartment 16 but with access/exposure to the sign via a window in bottom of the sign (FIG. 2).

The light sensor 24 and the processing circuitry are features of the circuit board 18 which is also a component of the compartment 16. The compartment and the surface of the housing are also fitted with a window 23 to permit ambient light and dark conditions to be detected by the light sensor 24.

The illumination device described herein is, candidly, a collection of easily sourced and assembled elements or parts. The battery, solar panel and LED are readily purchased and conventionally configured to operate in the manner prescribed herein. The other elements of the device 10, viz., the bracket, housing and solar panel frame can be easily fabricated from a variety of inexpensive, yet durable, materials, including plastics, metals and composites. A required feature of any material used in the fabrication of the device, especially the bracket, housing and solar panel, is a demonstrated or proven resistance to weather extremes. The processing circuit board 18 is, however, necessarily unique to the instant collection of components and is critical to the functioning of the device 10.

While the foregoing is a detailed and complete description of the preferred embodiments of the disclosed illumination device, it should be apparent that numerous variations and modifications can be made and employed to implement the overall purpose of the disclosed device without deviating or departing from the spirit of the invention, which is fairly defined by the appended claims.

1. A traffic sign illumination device which comprises: a bracket attachable to said sign;
a housing integral with said frame, a compartment fitting within said housing for the containment of electrical components conducive to the illumination of said sign, said components comprising: a stored energy source, a light emitting means, a light sensor and processing circuitry providing electrical communication between said energy source, said light emitting means and said light sensor.

2. An illumination device according to claim 1 further comprising a solar panel attached to said device and in electrical communication with said stored energy source for recharging said source.

3. An illumination device according to claim 2 wherein said stored energy source is a battery.

4. An illumination device according to claim 2 wherein said light emitting means is an LED.

5. An illumination device according to claim 2 wherein said solar panel is adjustably attached to said illumination device.

6. An illumination device according to claim 2 wherein said light emitting means emits a flashing light.
